(19) United States
(12) Patent Application Publication
(10) Pub. No.: US 2015/0282503 A1
(43) Pub. Date: Oct. 8, 2015

(54) Producing Therapeutic Proteins

(71) Applicant: Synageva BioPharma Corp., Lexington, MA (US)

(72) Inventors: Adam Albert Paszek, Athens, GA (US); Mark Michael Hazard, Athens, GA (US); Glen Williams, Apex, NC (US)

(21) Appl. No.: 14/675,896

(22) Filed: Apr. 1, 2015

Related U.S. Application Data
(60) Provisional application No. 61/974,242, filed on Apr. 2, 2014.

(51) Int. Cl. A23J 1/09; A01K 31/19; A01K 31/20; A01K 31/00; B01D 53/02; A01K 31/16

(52) U.S. Cl. CPC A23J 1/09; B01D 53/02; A01K 31/165; A01K 31/20; A01K 31/005; A01K 31/19

(57) ABSTRACT

Facilities, methods, and systems to produce therapeutic protein(s) can include collecting eggs from transgenic avian in a production unit in a building; transferring the eggs to a harvesting unit in the building; and harvesting egg white or egg yolk from the eggs in the harvesting unit.

### CROSS-REFERENCE TO RELATED APPLICATIONS

This application claims the benefit of U.S. Provisional Application No. 61/974,242, filed on Apr. 2, 2014, which is incorporated by reference in its entirety as part of this application.

### FIELD

This disclosure relates to facilities, methods, and systems to produce therapeutic protein(s).

### BACKGROUND

Proteins have been used as pharmaceuticals since the 1920s. Several proteins are prepared from bacteria. This approach is limited by the fact that bacteria cannot synthesize complex proteins such as monoclonal antibodies or coagulation blood factors which must be matured by post-translational modifications to be active or stable in vivo.

Several transgenic animal species can produce recombinant proteins. One system being implemented is milk from transgenic mammals. A second system being implemented is egg white from transgenic avian (e.g., chickens, quails, or turkeys). Two monoclonal antibodies and human interferon-131a have been recovered from chicken egg white.

### SUMMARY

This disclosure relates to facilities, methods, and systems to produce therapeutic protein(s). The facilities can be designed to house transgenic avians (e.g., chickens, turkeys, quails) and harvest egg white or egg yolk, which contains a therapeutic protein or proteins, from their eggs. Each facility houses both a production unit and a protein harvesting unit which can reduce time and costs from egg laying to material preparation. However, the production unit (e.g., egg laying and/or animal management area) and egg white or egg yolk harvest unit are tightly controlled independently from one another to provide biosecurity and specified levels of cleanliness. The described facilities, methods, and systems manage the flow of eggs whose egg white or egg yolk contains a therapeutic protein or proteins from the production unit to the harvesting unit to provide biosecurity and product stability in a highly time- and temperature-sensitive manner and provide high efficiency in biopharmaceutical production while also maintaining biosecurity and a good manufacturing practice (GMP) compliant environment for egg white or egg yolk harvesting.

In one aspect, methods of producing proteins can include: collecting eggs from transgenic avian in a production unit in a building; transferring the eggs to a harvesting unit in the building; and harvesting egg white from the eggs in the harvesting unit. Embodiments can include one or more of the following features.

In some embodiments, methods can include inspecting eggs for visible cracks and size. In some cases, methods can include wiping eggs which are visibly dirty by hand with distilled water within 20 minutes of collection and/or discarding eggs with stains or material that is not removed by wiping. In some cases, methods can include spraying the eggs with alcohol (e.g., 70% ethanol) to completely saturate shells of the eggs, allowing the eggs to dry until the shells become visibly dry, and then spraying the eggs with alcohol (e.g., 70% ethanol) to completely saturate the shells.

In some embodiments, methods can include placing collected eggs in containers labeled with a production room identification, product, zygosity, and/or lay date. In some cases, the containers can be labeled with at least one of a box number, product, a number of eggs, or a generation.

In some embodiments, methods can include housing the transgenic avian in multiple production rooms in a biosecurity area in the production unit. In some cases, methods can include passing air through high-efficiency particulate absorption filters before it is introduced to the production rooms. Methods can include housing between 400 and 10,000 (e.g., more than 2,000, more than 4,000, less than 7,500, and/or less than 5,000) transgenic avian and/or housing between 400 and 1,000 (e.g., more than 500, more than 750, less than 750, and/or less than 600) transgenic avian in each production room of the multiple production rooms. In some cases, methods can include cleaning each production room of the multiple production rooms daily. In some cases, methods can include controlling air flow to the biosecurity area such that air pressure is higher in the multiple production rooms than in adjacent rooms accessible from the multiple production rooms (e.g., independently controlling air flow to each of the multiple production rooms). In some cases, methods can include comprising breeding transgenic avian in the biosecurity area and/or hatching transgenic avian in the biosecurity area.

In some embodiments, methods can include collecting eggs at least twice (e.g., three times, in some embodiments, four times, or five times) per day. In some cases, methods can include manually collecting the eggs.

In some embodiments, methods can include placing the eggs in a storage unit with an internal temperature set to 2° C.-10° C. (e.g., between 4°-8° C., more than 2° C., more than 4° C., less than 8° C., less than 6° C., and/or less 5° C.) within 4 hours (e.g., within 3 hours, 2 hours, or 1 hour) of collection. In some cases, methods can include transferring the eggs to the harvesting unit before storing the eggs.

In some embodiments, methods can include transferring the eggs to the harvesting unit in the building within 4 hours (e.g., within 3 hours, 2 hours, or 1 hour) of collection.

In some embodiments, methods can include cleaning eggs in a preparation room in the harvesting unit. In some cases, cleaning eggs in the preparation room may comprise cleaning the eggs with alcohol (e.g., a 70% ethanol rinse). In some cases, methods can include transferring eggs from the preparation room into a clean room compliant with good manufacturing practices standards.

In some embodiments, methods may include manually cracking eggs and depositing contents into a sterile tissue culture dish. In some cases, methods can include separating egg white or egg yolk out of the sterile tissue culture dish. In some cases, methods can include depositing egg white or egg yolk into multiple sterile containers. In some cases, methods can include analyzing samples of egg white or egg yolk from each container of the multiple sterile containers. In some cases, methods can also include labeling each container of the multiple sterile containers to identify a production room of origin, product, zygosity, and/or lay date. In some cases, methods can include disinfecting the exterior of each container of the multiple sterile containers. In some cases, methods may include transferring each container of the multiple sterile containers with egg white into storage freezers (e.g., transferring into storage freezers within 6 hours (e.g., within 5 hours, 4 hours, 3 hours, 2 hours, or 1 hour) of starting manually cracking eggs).

In some embodiments, methods can include showering and completing changing clothing before entering the production unit. In some cases, methods can include donning disposable coveralls and shoe covers before entering a biosecurity area housing the at least one production room. In some cases, methods can include removing disposable coveralls and shoe covers before exiting the biosecurity area. In some cases, methods include showering and completing changing clothing before leaving the production unit.

In some embodiments, methods can include collecting blood from the transgenic avian monthly and analyzing for infection and/or other general health of the avian. In some cases, methods can include performing polymerase chain reaction analysis of blood collected from transgenic avian.

In some embodiments, methods can include irradiating feed for the transgenic avian and/or providing irradiated feed to the transgenic avian.

In one aspect, protein production facilities can include: an egg production unit in a building, the egg production unit comprising a biosecurity area; and an egg white/yolk harvesting unit in the building. At least one area of the harvesting unit has a room or section that is compliant with good manufacturing practices. In one aspect, the harvesting unit can include an egg white harvesting room that complies with good manufacturing practices. Embodiments can include one or more of the following features.

In some embodiments, facilities can include between 400 and 20,000 transgenic avian in the biosecurity area. In some embodiments, facilities include between 200 and 30,000 transgenic avian in the biosecurity area. In some embodiments, facilities can include, more than 2,000, more than 4,000, more than 5,000, more than 7,500, more than 10,000, or more than 15,000 transgenic avian in the biosecurity area.

In some embodiments, the egg production unit may comprise multiple production rooms in the biosecurity area, each production room configured to house between 100 and 1,000 avian. In other embodiments, each product room can be configured to house 50 to 500 avian. In yet other embodiments, each product room can be configured to house about 100, 200, 300, 400, 500, 600, 700, 800, 900, or 1000 avian. In some cases, facilities can include 400 and 1,000 transgenic avian in each production room. In some cases, facilities can include between 200 and 1,000 transgenic avian in each production room. In some cases, facilities can include an air handling system for the production rooms that comprises high-efficiency particulate absorption filters. The air handling system can be operable to control air flow to the biosecurity area such that air pressure is higher in each of the multiple production rooms than in adjacent rooms accessible from the multiple production rooms.

In some embodiments, facilities can include a breeding room and male housing room in the biosecurity area. In some cases, facilities can include one or more hatching and one or more brooding rooms in the biosecurity area.

In some embodiments, facilities can include freezers for storing harvested egg white.

In some embodiments, facilities can include one or more airlocks disposed for personnel access between the biosecurity area and other portions of the production unit. In some embodiments, facilities include at least two airlocks disposed for personnel access between the biosecurity area and other portions of the production unit.

In some embodiments, facilities can include one or more airlock disposed for personnel access between the harvesting room and other portions of the egg white harvesting unit. In some embodiments, facilities can include at least two airlocks disposed for personnel access between the harvesting room and other portions of the egg white harvesting unit. In some cases, the one or more airlocks can be HEPA filtered. In one embodiment, the one or more airlocks can be ISO Class 7 compliant.

In some embodiments, the harvesting room can be or can contain a HEPA filtered room. In some cases, the HEPA filtered room can be ISO Class 8 standards compliant. In some cases the HEPA filtered room can be surrounded by soft-walls. In some cases, facilities can include a pass-through in a common wall between the soft-walled HEPA filtered room and a portion of the harvesting unit outside harvesting room.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a schematic illustrating an exemplary protein production facility.

FIGS. 2A-2D are plan views of portions of an exemplary protein production facility.

FIGS. 3A and 3B are plan views of an exemplary protein production facility.

FIG. 4 is a plan view of an exemplary protein production facility.

FIG. 5 is a schematic illustrating another exemplary protein production facility.

FIG. 6 is plan views of an exemplary protein production facility.

Like reference symbols in the various drawings indicate like elements.

### DETAILED DESCRIPTION

This disclosure relates to facilities designed to house transgenic avian (e.g., chickens, quails or turkeys) and harvest egg content (e.g., egg white and/or egg yolk) from their eggs, which contains a therapeutic protein or proteins. The facility design and production methods described below enable colocation of a production unit with a protein harvesting unit. This approach can provide high efficiency in biopharmaceutical production while also maintaining biosecurity and a GMP compliant environment for egg white harvesting. For the sake of simplicity, the following disclosure describes facilities and methods drawn to harvesting egg white. However, the methods and facilities are also applicable to harvesting of the entire contents of the egg or components thereof, such as egg yolk.

### Exemplary Protein Production Facility

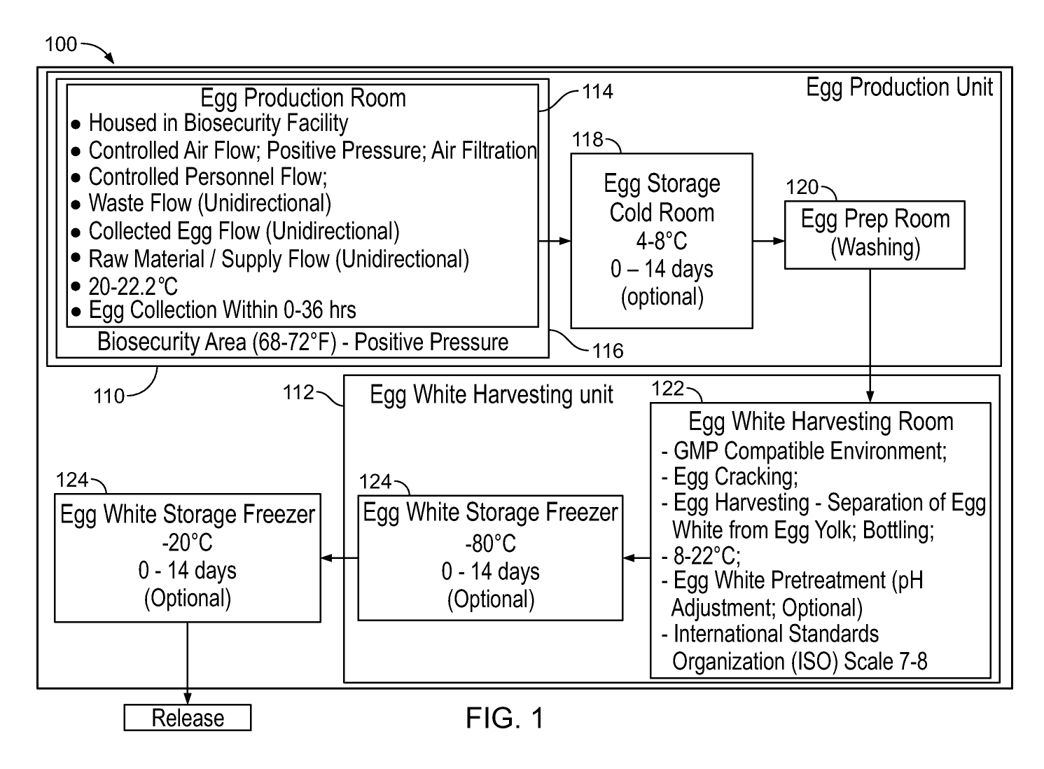

Referring to FIG. 1, an exemplary protein production facility 100 designed to produce egg white on commercial scale (e.g., at least 50 liters of egg white per day) includes a production unit 110 and a protein harvesting unit 112. The flow of air, personnel, and materials are controlled within the production facility 100 to provide biosecurity and specified levels of cleanliness during the egg white production steps.

Egg production rooms 114 are located in a biosecurity area 116 within the production unit 110. Each egg production room 114 in protein production facility 100 has separate air supply and return vents. Both the air supply and return vents are filtered to limit airborne transfer of particles into (e.g., using high-efficiency particulate absorption (HEPA) filters) or out (e.g., using dust filters) of the egg production rooms 114. The HVAC system controls the air supply and return vents provide positive pressure within the egg production rooms 114. Unidirectional flow of personnel, waste, collected eggs, and raw materials and supplies help provide biosecurity. The egg production rooms are maintained at 20-22.2° C. and eggs are collected within 36 hours (e.g., within 24 hours, within 18 hours, within 12 hours, within 8 hours, within 6 hours, within 4 hours, or within 2 hours) of being laid.

Eggs produced in the egg production rooms 114 are inspected for shell cracks and size before transfer to egg preparation room 120. The egg preparation room 120 is located in the production unit 110. In some facilities, egg preparation room 120 is located inside the egg white harvesting unit. In some protein production facilities, eggs are washed in an egg preparation room in the harvesting unit 112 in addition to or instead of being washed in an egg preparation room in the production unit 110.

Cold rooms for egg storage and overall egg white harvest storage are strategically placed within the facility to control the flow of the egg product and ensure the stability of the product in the eggs. An egg cold storage room 118 is located in the production unit 110 for optional storage of inspected eggs for up to 14 days before they are transferred into the egg white harvesting unit 112. The temperature of the egg cold storage room 118 is maintained at 4-8° C. In some facilities, an egg cold storage room 118 is located in the protein harvesting unit 112 instead of or in addition to the egg cold storage room 118 in the production unit 110.

An egg white harvesting room or rooms 122 are located in the egg white harvesting unit 112. Egg white harvesting rooms 122 are a good manufacturing practices (GMP). Optionally, in certain embodiments, the egg white harvesting room(s) can be an environment meeting International Standards Organization (ISO) scale 7-8. Temperatures in the egg white harvesting rooms are maintained at 8-22° C. Egg cracking, egg white harvesting (e.g., separation of egg white from egg yolk); bottling, and optionally egg white pretreatment (e.g., optional pH adjustment) are performed in the egg white harvesting rooms 122.

Egg white storage freezers 124 provided to store harvested egg white before release or shipment can be located in the egg white harvesting unit 112, outside the harvesting unit 112, or in both locations. The exemplary protein production facility 100 includes an egg white storage freezer 124 set to maintain a temperature of −20° C.-80° C. located in the protein harvesting unit 112 and a second egg white storage freezer 124 set to maintain a temperature of −20° C. located outside the protein harvesting room/unit 112. Some facilities have different freezer arrangements. The temperature at which egg white is stored depends on what temperature is appropriate to maintain the stability of the proteins being produced. When less cooling is needed, less energy is used and, in some instances, less expensive equipment can be used. For example, some facilities only include −20 or −80° C. freezers for egg white storage. Other facilities only include cold rooms where freezing is not necessary.

Freezing is not necessary if purification of proteins from the harvested egg white is initiated immediately or protein being produced is stable above freezing. However, the harvested egg white is typically frozen while quality assurance procedures are performed. It is anticipated that performing quality assurance procedures will take between 3 and 6 weeks. The harvested egg whites can be stored for up to a year before protein purification begins.

### Second Exemplary Protein Production Facility

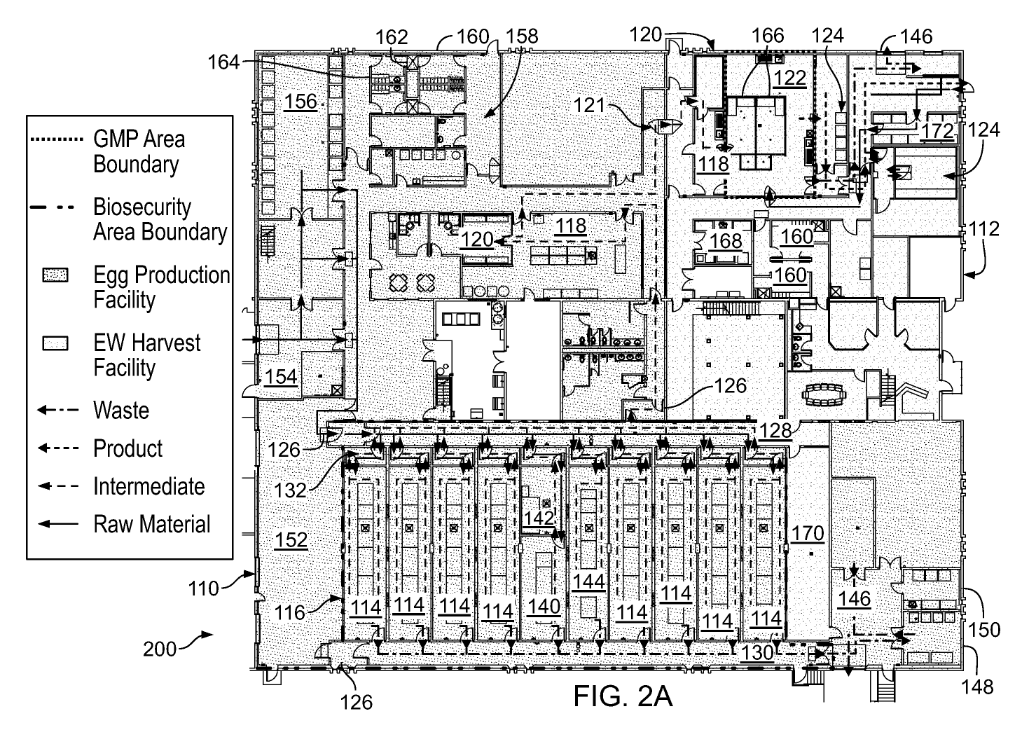

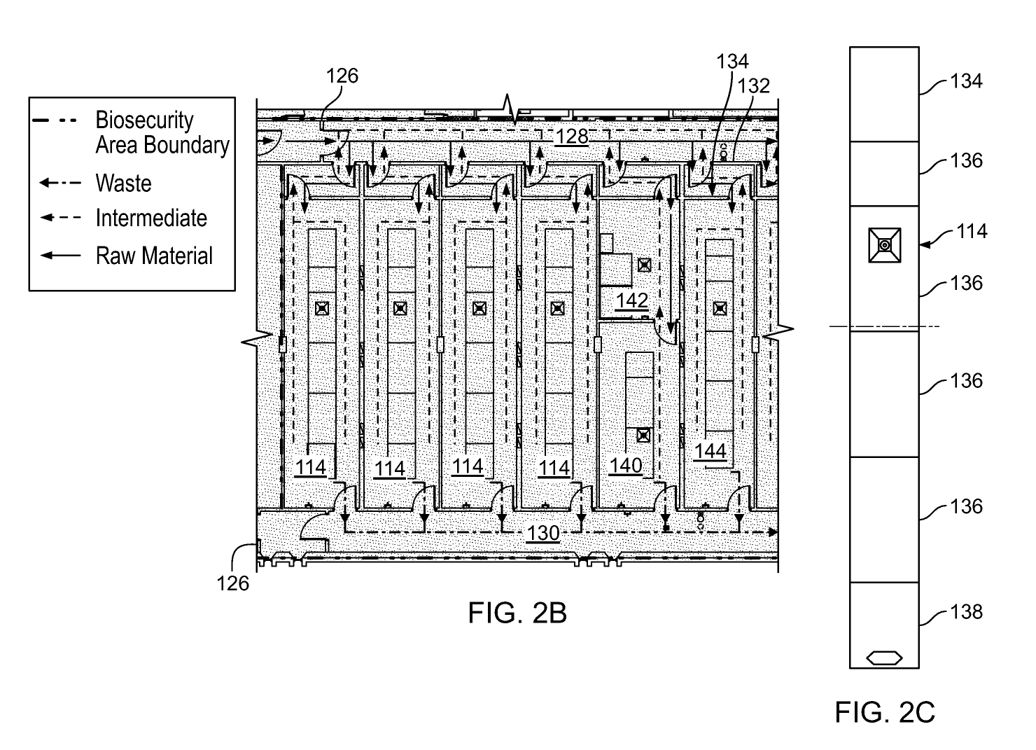

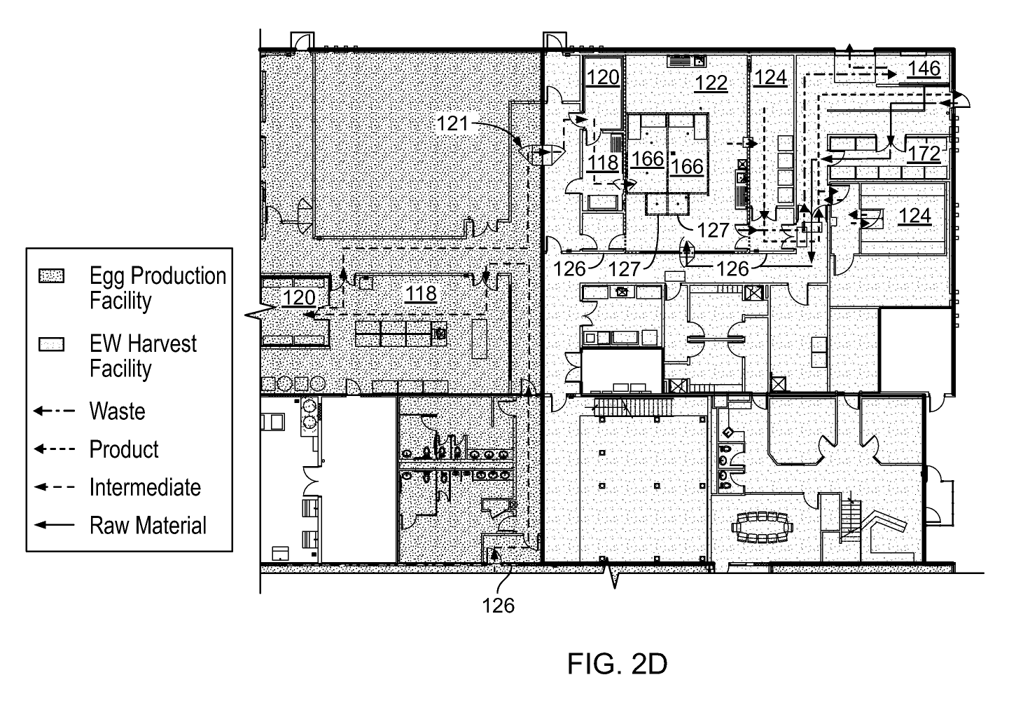

FIGS. 2A-2D illustrate an exemplary non-limiting protein production facility 200 designed to produce up to 3,000 (e.g., 2,200) liters of egg white per month containing a therapeutic protein or proteins. The biosecurity area 116 of protein production facility 200 has eight egg production rooms 114. Segregation of animals into multiple separate egg production rooms 114 allows each room to be taken down periodically for deep cleaning, to control air flow separately, and to control the spread of disease.

The facility also includes a variety of other system to preserve biosecurity. The facility 200 includes appropriate fencing well away from the building perimeter (e.g., 30 to 50 yards) to insure that no animals get near the building. This technique enhances the level of biosecurity. The mechanical systems are configured with complete redundancy to insure 100% backup. An emergency power generator automatically provides appropriate electrical power on the facility in the event of an electrical failure from the local utility. Closed circuit cameras are monitored to verify that the material flow patterns described above are followed. Epoxy flooring is utilized throughout the facility for the housing of the transgenic avians to insure maximum cleanability.

### Production Unit

In the exemplary protein production facility 200, the production unit 110 includes airlocks 126, an entry corridor 128, and an exit corridor 130 located in the biosecurity area 116. The airlocks 126 provide access between the biosecurity area 116 and the production staging area 152 and between the biosecurity area 116 and the corridor leading towards the egg preparation room 118. The egg production rooms 114 extend in parallel from an entry corridor 128 to an exit corridor 130. Each egg production room 114 has an associated anteroom 132 which separates the egg production room 114 from the entry corridor 128. Doors are provided between the entry corridor 128 and the anterooms 132 and between the anterooms 132 and the egg production rooms 114. In some facilities, an access hatch 134 is present in the wall between each anteroom 132 and the associated egg production room 114. An automatically closing door separates the exit corridor 130 from the adjacent loading dock 146 and associated rooms.

In the exemplary protein production facility 200, the biosecurity area 116 also houses a breeding room 140, a hatching room 142, and a brooding room 144. Some facilities are capable of both, the natural and artificial insemination and some facilities use only artificial insemination to produce transgenic avians for protein production and contain both hatching and brooding equipment. The avians can be produced, for example, as described in U.S. Pat. No. 7,511,120 which is incorporated herein by reference in its entirety.

The genotype of a hen and its laid egg is referred to as the zygosity which in relation to gene responsible for produced protein is either homozygous or hemizygous. Eggs containing protein of interest expressed from a gene present on both sets of avian chromosomes are referred to as homozygous and eggs containing protein of interest expressed from a gene present on only one of two avian chromosomes are referred to as hemi or heterozygous. Transgenic avians and eggs with different zygosity are kept isolated from each other. Eggs with common zygosity and protein of interest referred to as a group of eggs.

Personnel entering the production unit 110 follow strict showering and gowning procedures. They enter the unit through entry corridor 158 and remove clothing worn outside the facility in outer locker rooms 160. After bathing in shower rooms 162, personnel don internal clothing (provide by facility and worn only in the facility) in inner locker rooms 164. Internal clothing includes, for example, shoes, socks, underwear, and coveralls. All clothing that may come in contact with the animal are maintained in the facility and laundered appropriately. Personnel proceeding into the biosecurity area 116 don a personal protective equipment (PPE) ensemble including, for example, shoe covers, disposable coveralls, mask, hairnets, and gloves on entry. The secondary PPE ensemble is removed on exiting the biosecurity area 116.

The egg production rooms 114 in the protein production facilities 200 are approximately 12 by 50 feet. Each egg production room 114 includes dedicated feed gear 134, multiple enclosures 136 housing transgenic avians, and dedicated waste gear 138 (see FIG. 2C). The enclosures 136 include state of the art equipment (e.g., galvanized wire mesh built floors and walls, belts for manure removal, water supply lines, mechanized feed supply system) to maximize ventilation, cleanliness, and overall health and well-being of the animals. The egg production rooms 114 incorporate the use of special LED lighting to reduce overall stress level of the transgenic avians along with the ability to simulate daylight and night hours.

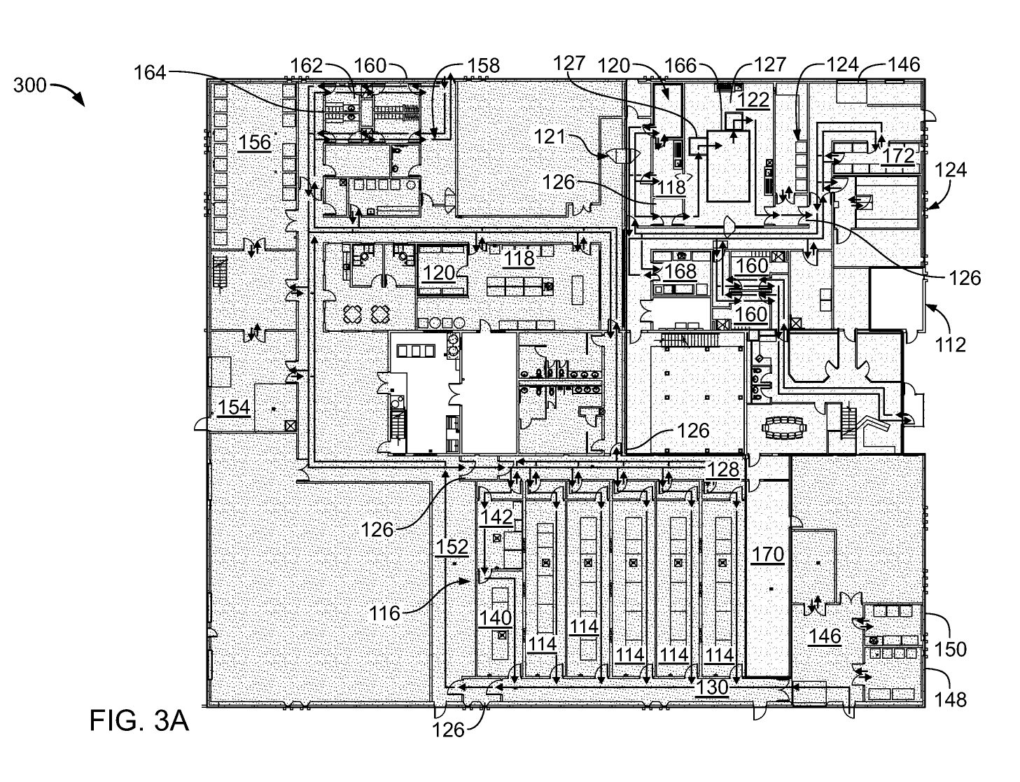

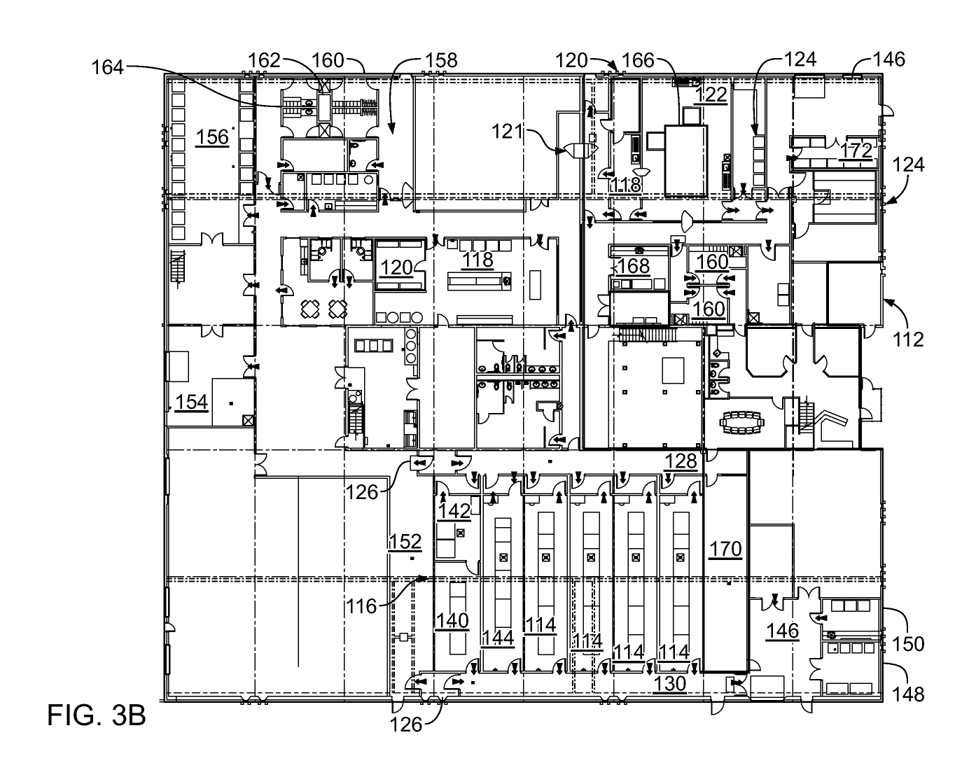

Personnel flow is unidirectional from room entrances near the feed gear 134 to the room exits near the waste gear 138. This reduces the likelihood that cross contamination occurs between rooms. Personnel flow through a protein production facility is discussed in more detail below with reference to FIG. 3A.

An automated water system is installed within each egg production room 114 to supply drinking and cleaning water for maintaining animal health. The drains within each egg production room 114 are independently piped to the main drain header to provide high levels of wastewater segregation and biosecurity between rooms.

The egg production rooms are under individual temperature control with a tolerance of +/−0.5° C. (based on BOD but in practice +/−1° C.) and are typically set to maintain a temperature between 20 and 22.2° C. Each room housing animals is under a differential pressure control that is positive to adjacent hallways. This reduces the likelihood of air migration from one egg production room 114 to another. Relative pressurization of different parts of the facility is discussed in more detail below with reference to FIG. 3B.

Air is delivered to each room of the protein production facility under strict temperature and humidity control and passes through HEPA filters. The HVAC system provides for a single pass design to help maintain full biosecurity with separate HVAC units zoned to separate different production areas. The HVAC systems design of individual rooms housing transgenic avians include the feature of low level returns to insure adequate ventilation and temperature control at all enclosure levels. The low level returns have particle filters to keep dust and animal dander from entering the duct work.

Air handling systems are located on the building roof. The air handling systems have side-mounted intakes and top-mounted air induction exhaust fans. The top-mounted air induction exhaust fans provide high exit velocity in an upwards direction and reduce the likelihood that discharge air is drawn into the air handling system intakes.

The animal rooms are designed for a flow rate providing approximately 20 air changes per hour to provide adequate ventilation, odor control and removal of dander within the rooms. Key HVAC equipment is located outside the internal facility environment for service capabilities without compromising biosecurity during maintenance activities. Due to the use of 100% outside air in the facility, an energy recovery facility is designed and installed to reduce overall operating costs.

### Egg White Harvesting Unit

In the exemplary protein production facility 200, the egg white harvesting unit 112 includes an egg storage cold room 120 and an egg preparation room 118 located between a pass-through 121 from the production unit 110 and the egg white harvesting room 122. The pass-throughs are openings in the wall having a dimension approximately 3-feet-by-2-feet made out of stainless metals, which facilitates transfer of the materials (e.g., eggs) from one unit to the other without requiring personnel to travel from one room to the other. Two egg cracking rooms 166 in the egg white harvesting room 122 are entered from outer portions of the egg white harvesting room 122 through anterooms 127. A pass-through 121 between the harvesting unit's egg preparation room 118 and the egg cracking room(s) 166 is provided for transfer of eggs. Produced egg white is stored in egg white storage freezers 124. At least one area of the egg white harvesting unit 112 is GMP compliant to ensure that one or more egg component(s) containing the pharmaceutical protein of interest is(are) processed in an environment suitable for pharmaceutical grade.

The egg white harvesting room 122 is GMP compliant. The egg cracking rooms 166 can be surrounded by a wall that separates the room from the rest of harvesting room. The egg white cracking room 166 can be soft-walled or hard-walled HEPA filtered rooms. The egg cracking rooms 166 and the associated anterooms 127 can be classified as low bioburden HEPA filtered environment or can comply with ISO Class 8 standards. The outer portions of the egg harvesting room 122 and the associated airlocks 126 can be classified as low bioburden HEPA filtered environment or can comply with ISO Class 7 standards.

Personnel entering the harvesting unit also follow gowning procedures that require donning coveralls in locker rooms 160 in the harvesting unit 112 before proceeding further into the harvesting unit 112. Personnel entering the egg harvesting room 122 don a PPE ensemble including, for example, shoe covers, disposable coveralls, mask, hairnets, and gloves on entry. The PPE ensemble is removed on exiting the egg harvesting room 122.

Supplies are brought into the harvesting unit 112 through loading dock 146 and quarantine/release room 172.

The harvesting unit includes a lab 168 where quality control (QC) checks are performed on produced egg white and also includes a viewing corridor 170 that allows visitors to inspect a production room without entering and breaking biosecurity.

### Material Flows

Material flow through the protein production facility 200 is configured to provide a high degree of biosecurity.

Raw material

Raw material flow is indicated on FIG. 2A by the arrows extending from fog room 154 to egg production rooms 114. All materials (e.g., feed, spare parts) brought into the production unit 110 undergo a wipe-down or atomized fogging to insure protection of the transgenic avians. In exemplary protein production facility 200, this takes place in a fog room 154 located directly adjacent the receiving loading dock (not shown) for the egg production unit 110 before being placed between rooms 154 and 156 or taken, for example, to production staging room 152. Personnel on the receiving loading dock bring material to the entrance of the fog room 154 but do not cross into the fog room 154. Personnel in the fog room 154 receive the material but do not cross out of the fog room 154 on to the loading dock.

Feed provided to the protein production facility 200 is irradiated offsite to increase biosecurity.

Raw materials (e.g., feed) being taken into the egg production rooms 114 is gathered in the staging room 152, before being taken through airlock 126 into the entry corridor 128. The materials are then placed in the anteroom 132 associated with the destination egg production room 114. The door between the anteroom 132 and the entry corridor 128 is closed before the door between the anteroom 132 and the egg production room 114 is opened and the materials are taken into the egg production room 114. No materials are transferred between egg production rooms and no materials, with the exception of eggs, are moved from a egg production room 114 back into the associated anteroom 132. Both raw materials and waste move unidirectionally towards the exit corridor.

After hens are bred in egg production rooms 114 with semen from males housed within each room or in the breeding room 140 using artificial insemination technique produced fertilized eggs are transferred to the hatching room 142. A three-team operation is used to transfer chicks from the hatching room 142 to the brooding room 144. One team in the hatching room crates chicks and transports the crates to the anteroom 132 associated with the hatching room 142. This team remains in the hatching room 142 until the transfer is complete and then exits through the breeding room 142 to exit corridor 130. A second team transports the crates from the anteroom 132 associated with the hatching room 142 to the anteroom 132 associated with the brooding room 144. This team remains in the entry corridor 128 and anterooms 132 until the transfer is complete and then exits through the brooding room 144 to exit corridor 130. A third team in the brooding room 144 receives the crates and places chicks in the enclosures. This team remains in the brooding room 144 until the transfer is complete and then exits to exit corridor 130. A similar operation is used to transfer young transgenic avians from the brooding room 144 to an egg production room 114 when the avians reach egg production age.

The entry corridor 128 and the anterooms 132 used in a transfer operation are clean and disinfected before the transfer operation and after the transfer operation. In any given transfer operation, transgenic avians are only transferred from a single source room to a single destination room.

Intermediate Material

The flow of intermediate material (i.e., eggs) is indicated on FIG. 2A by the arrows extending from the egg production rooms 114 back through the entry corridor 128 to the pass-through 121 between the production unit 110 and the harvesting unit 112. Eggs collected in an egg production room 114 are passed through the door 134 (FIG. 2B) between the egg production room 114 and the associated anteroom 132. Personnel collecting the eggs do not return to the anteroom but proceed through the egg production room 114 to the exit corridor 130.

Prior to egg collection, personnel disinfect the appropriate number of color-coded egg flats with 70% ethanol. The flats are allowed to dry in the production staging room 152. The egg flats are color-coded to correspond to the different products being produced in different egg production rooms 114. For example, in facility 200, yellow egg flats are used to carry eggs from egg production rooms producing human protein X, brown egg flats are used to carry eggs from egg production rooms producing human protein Y, and blue egg flats are used to carry eggs from egg production rooms producing human protein Z. The product being produced in a specific egg production room is specified on the front of each egg production room.

After the color-coded egg flats are taken into an egg production room, all eggs found on the egg rollout are collected and placed onto the flats with large end up. A maximum of 30 eggs are collected per flat starting using 3 empty flats nested together and, once the top flat is filled, rotating to fill the next flat until the stack is 5 flats with eggs high. The eggs are collected at least two times per day.

After collection is complete, the total number of good and bad eggs for the given egg pickup is determined. All eggs are inspected for visible cracks and size. Eggs with large cracks, broken eggs, and eggs below a minimum size (e.g., 39 grams) are discarded immediately into a biohazard collection bag. These eggs are included in egg pickup count. The eggs are treated as biological waste and, at completion of egg collection in an egg production room 114, the biohazard bag is placed in a second biohazard bag (double bagged).

The good eggs are separated into two groups: visibly clean eggs and dirty eggs. The dirty eggs are wiped by hand with distilled water and allowed to dry. The eggs are not scrubbed. Rather, eggs with any stains or material that is not easily removed are discarded. The eggs are wiped clean within 20 minutes of initial collection. Both groups of eggs are sprayed with 70% ethanol to completely saturate egg surface, the eggs are allowed to dry until the shell surface becomes visibly dry, and then sprayed again with 70% ethanol. This provides all eggs with two separate exposures to 70% ethanol. The flats of egg are loaded into plastic containers with lids. Any existing labels on the containers are removed and discarded and the containers are disinfected before the containers are brought into an egg production room 114. A maximum of 5 flats of eggs should be put into one container.

The egg production room number, product code/product name, generation, eggs lay date, and number of usable eggs are recorded on an egg transfer record and affixed to container lid. The container lid is placed on container and attached with matching colored tape (i.e., tape and egg flat color are the same) to the lid so that the lid cannot be removed. Two labels are attached to the container, one on the top and one on the front. The labels are applied over ends of the tape and contain the information including: box number, eggs lay date, product, room number, number of eggs, collection time (1st, 2nd, or 3rd) and generation. Information on zygosity can be optionally included in the labels.

At the beginning of each month, a new daily egg collection record is started for each egg production room 114 in use. The daily egg collection record is labeled with the room number, product, generation, and month/year of egg collection. The daily egg collection record is annotated with the initials of the egg collector, the time, and the total number of good and bad eggs within the column corresponding to the day of the month for each pickup. If only 2 egg collections are performed for a given room on a particular day, the section for the 3rd collection is crossed out with a single line, NA and initialed/dated.

The eggs are placed in the airlock 126 between the entry corridor 128 and the corridor leading to the egg preparation room 118 of the production unit 110. Personnel in the biosecurity area 116 do not pass through this airlock 126. Rather, personnel in the corridor take the eggs out of the airlock 126. In protein production facility 200, these personnel typically take the eggs directly to pass-through 121 to be transferred into the harvesting unit.

In some cases, these personnel transport the eggs to the egg preparation room 118 of the production unit 110 for processing as described below. The eggs may be stored in cold storage room 120 before being transferred into the harvesting unit or maybe taken after processing. Personnel entering the egg preparation room 118 (e.g., after receipt of transported eggs from the egg production room 114 of origin) wear a PPE ensemble.

In the egg preparation room 118, an egg printer (e.g., a Nuovo Ag Egg Printer) can be used to label at least two eggs on each flat prior to flats of eggs stored in the production unit's egg cold storage room 120 or transferred to the harvesting unit 112. For example, eggs on opposite corners of each flat can be identified with the product code, room number, generation, and date using black ink and/or the colored ink corresponding to the product code. Only one group of eggs may be contained within the egg preparation room 118 housing the egg printer at a time with eggs originating from other egg production rooms 114 being kept separated.

If not being immediately transferred to the harvesting unit 112, the eggs can be stored in the egg storage cold room 120. The eggs are transferred to one of the designated production storage coolers located in the egg storage cold room 120. Personnel entering the egg storage cold room 120 wear a PPE ensemble and don new shoe covers when crossing the room threshold into the egg preparation room 118. Each designated cooler has signage indicating the egg production room number of egg origin, product code, and color-code for correlating eggs. Eggs from different egg production rooms 114 are segregated in each cooler.

Eggs are managed in a “first-in, first-out” fashion. To facilitate this, the eggs are transferred to the last remaining flat (partial) in chronological order within the designated cooler and eggs are arranged in a specific order. For example, eggs can be placed onto the rear left portion of a flat and each row is filled with eggs from left to right and from the rear to the front. Flats can be stacked up to five in succession with the oldest dated eggs on the bottom. Each stack of five flats can be arranged from rear left, rear right, front left, and front right.

The temperature of each designated storage cooler is maintained between 2° C.-10° C. (e.g., between 4° C.-8° C.). A temperature recording device (chart or digital recorder) is used to monitor each designated storage cooler. For chart recorders, the charts are changed on each temperature recording device every Monday. The start date, “new”, and initials are recorded in the box on the front of the chart record as shown above. The product code (e.g., “Protein X”) is recorded in another box located on the front of the chart record. The back of the chart record is identified with the cooler ID, product code, chart recorder serial number, change date, and initials of the person changing the chart at the end of the cycle. All chart records are validated and signed by management personnel after weekly changing before being filed. A chart recorder and egg storage cooler inspection record is completed daily for each designated cooler. The appropriate information is recorded in the table based upon daily observation of the temperature chart recorder within the cooler. Annotations of “Sat” or “Unsat” are used to indicate whether the chart recorder is working satisfactory or not. Comments for “Unsat” observations (for either cooler or chart recorder) are recorded and supervisory personnel are notified immediately.

Any excursion outside the stated temperature range or deviation from the standard procedures are documented and investigated. The reasons for any difficulties achieving and maintaining the target temperature are determined and the appropriate corrective action are taken by the facility staff. If the nature of the problem cannot be determined or corrected, a service technician are called in to evaluate the situation and to initiate the service on the equipment. At all times, the integrity of the product are of primary concern and are maintained appropriately.

Depending on the product but within 14 days of collection, eggs are transferred to the egg white harvesting unit 112 via the pass-through 121 (e.g., either immediately after collection or after labeling and/or storage in the production unit cold room). A production unit technician coordinates the transfer with a harvesting unit technician and documents the date and time of transfer on an egg transfer record. The harvesting technician documents the date and time of receipt on the egg transfer record. Each of the steps of process described below are documented on the egg transfer record by the technician who performs the step and initialed a second technician who witness the step being performed.

After transfer to the egg white harvesting unit 112, the eggs can be taken directly into the egg preparation room 118 but are typically stored in egg storage cold room 118. When being stored, the eggs are taken directly from the pass-through 121 to the egg storage cold room 118 to minimize the time that the eggs are outside a cooler. The same procedures described above for egg handling in the production unit's egg storage cold room 118 are used for egg handling in the harvesting unit's egg storage cold room 118.

Prior to harvesting egg white from the eggs, the eggs are removed from storage (if applicable) and inspected. If a temperature monitor (e.g., a DeltaTRAK monitor) is included with the transferred eggs, satisfactory storage temperature between is verified. A harvesting unit technician verifies that label information (e.g., egg production room number, product code, generation, zygosity, and lay date range) on the container matches the egg transfer record or egg shipment record. When temperature monitors are used for egg transfer, the temperature monitor serial numbers and corresponding origin egg production room numbers are recorded on the batch record.

Candling is the process of illuminating or passing a light through an egg to observe the internal quality of an egg. Under normal conditions, light passes through the transparent egg white and highlights the prominent yolk. Extraneous bodies, blood spots, cracks within the egg shell or massive internal contamination are detected by candling and such eggs with inadequate internal quality are discarded.

In the protein production facility 200, a harvesting technician candles the eggs in the egg preparation room 118 to identify eggs with cracks, visible blood spots, and/or extraneous bodies. The technician turns off lights in candling area. Only eggs from a single egg production room are candled together in order to maintain segregation of eggs produced in each egg production room. All eggs with cracks, visible blood spots, and/or extraneous bodies are discarded. The results of candling (e.g., Box number/Cooler number, number of eggs candled for each Box number/Cooler number, number of eggs discarded, and number of good eggs) are recorded on the egg inspection form before the technician and witness initial and date. In some facilities, egg production unit personnel may candle the eggs before transfer to the harvesting unit 112.

After inspection, the eggs are cleaned in the egg preparation room 118. Approximately 8 liters of water of at least U.S. Pharmacopeia (USP) grade is poured into a 16-L capacity square plastic tray. An egg flat with the eggs being cleaned is dipped into the water and agitated while flat to remove loose debris/dust. The tray is removed from the water to let excess water drain from the flat. Each tray is placed on a table or cart until all flats for a given crate are rinsed. The technician changes the water when cloudiness appears. After the initial water rinse, approximately 8 liters of 70% ethanol is poured into a 16-L capacity square plastic tray (approximately 8 liters). Each egg flat is sprayed with 70% isopropyl alcohol and then placed in the plastic tray containing the ethanol before the tray, flat, and eggs are transferred through pass-through 121 into egg cracking room 166.

Product

In preparation for harvesting egg white, the harvesting unit technician and a witness verify that the egg white harvesting room 122 and the egg cracking room(s) 166 have been disinfected within 24 hours prior to use before initialing and dating the batch record. Personnel entering the egg white harvesting room 122 don a PPE ensemble including, for example, shoe covers, disposable coveralls, mask, hairnets, and gloves on entry in the anteroom 127. Harvesting unit technicians initiate a viable particle count and perform a total particle count in egg white harvesting room 122.

The protein production facility 200 harvests egg whites manually using the process described below. However, some protein production facilities and harvest egg whites mechanically.

The start time, as defined by the cracking of eggs and separation of egg white for harvest, is recorded on the egg transfer record. Working one egg at a time per operator, harvesting unit technicians crack eggs and deposit contents into a sterile tissue culture dish. Any egg white that has a ruptured yolk or appears contaminated is discarded rather than being placed in the sterile tissue culture dish. The entire dish is discarded if there is any contamination in the culture dish. A sterile scoop is used to remove the egg yolk from the dish leaving as much egg white in the dish as possible. The scoop is discarded after touching an egg shell, the bench, any part of one's body, any other item, or if scoop has visible yolk contamination. The egg yolk, egg shells, and any other discarded materials are placed in a biohazard bag.

Harvested egg white is carefully deposit into sterile 1-liter bottle (e.g., a Corning bottle). After the 1-liter bottle is filled, the egg white is transferred from the 1-liter sterile bottle to a sterile 4-liter bottle (e.g., a Biotainer bottle). The procedure is repeated until volume in 4-liter bottle reaches a maximum volume of approximately 3.2 liters. This process is repeated the egg white from all eggs in the egg cracking room(s) 166 is completed. On completion, the end time of harvest is recorded and the 4-liter bottles are transferred from the egg cracking room(s) 166 to the egg harvesting room 122.

Each 4-liter bottle is sampled in the egg cracking room 166 using a 5-millilter or 10-milliliter pipette. Pipets are discarded after sampling and are never used for different containers. Prior to sampling, the contents shaken vigorously within each 4-liter bottle to mix the thin and thick portions of the egg white for greater homogeneity. A pipette is used to remove egg white from the 4-liter bottle and place the sample in a 1-milliliter cryrovial. Eight 1-milliliter samples are collected and the cryovials are placed into a cryobox in chronological order. The pipette is discarded.

All weighing, labeling and bagging is performed outside of the egg cracking room 166. After sampling is complete, a balance is used to determine mass after tare. For each of the 4-liter bottles containing egg white, a label specifying mass (g) is printed and placed below primary identification label. The primary identification label can follow the format EW-[protein code]-date-[bottle number] [facility code]. For example, “EW-Protein X-121113-01 H” would be the first bottle of egg white harvested from Protein X eggs on 11 Dec. 2013 at the facility “H”. The 4-liter bottles and associated sample vials are each labeled individually with this information. In some facilities, containers are labeled with a bar code or serial number that is associated in a database with information such as, for example, egg production room number, product code, generation, zygosity, and lay date range, instead of or in addition to having this information recorded directly in the label.

The number of labels made, applied, and destroyed are recorded. The labels are reconciled to confirm that the labels applied plus one sample label, plus the number of labels destroyed, divided by the total number of labels made equals 100. In some cases, additional steps such as, for example, pH adjustment, egg white clarification and filtration are performed in the egg white harvesting room.

Each 4-liter bottle is inspected for egg white residue and any visible material on bottle exterior is wiped and disinfected with 70% IPA before the 4-liter bottle is placed into a freezer bag (e.g., a 8″×4″×22″ freezer bag). The top portion of the freezer bag is twisted, the open end goose-necked, and the bag secured using 11″ zip ties to seal bag closed. The bottle number, lay dates, and volume are entered into egg white harvest record. The egg production room number, number of eggs received, number discarded (due to broken yolk, compromise, etc), number harvested, total mass for a witness, and date are recorded in the egg accountability matrix. The egg white 4-liter bottles and sample vials are transferred −20° C. storage freezers. All bags of egg waste are transferred to designated waste storage for proper disposal following local biological waste procedures.

Sample request forms (SRFs) are completed for each test required for 4-liter bottles and submitted to quality control (QC). Signature/date, sample description for each day, sample amount (for example, 7×1 mL), and test requested are recorded and samples are logged into the QC sample log book. The SRFs for each test are documented on egg transfer record for each given test with both operator and witness initialing and dating after completion. For each 4-liter bottle, four samples are submitted to QC for the following tests: endotoxin; bioburden; viral PCR; and enzyme activity (for information only); and four 1 milliliter samples are stored in −20° C. freezer for retention.

The bottle number, inclusive lay dates, mass, room identifications, operator, witness, date, and initial freezer location are recorded in the egg white harvest record and the harvest identifications, zygosity, lay dates, and associated mass are entered into the appropriate database.

All remaining materials are discarded from the egg harvesting room and egg cracking rooms between homozygous and hemizygous egg white harvests for the same protein of interest. Between harvests for different proteins of interest, a line clearance is completed and the time, date, and initials are documented on a placard secured to the egg harvesting room.

Waste

The waste systems provide semiautomatic removal of manure and unidirectional flow of waste to waste management is to ensure appropriate removal from the production unit 110. Waste flow in the production unit 110 is indicated on FIG. 2A by the arrows extending from the egg production rooms 114, the breeding room 140, the hatching room 142, and the brooding room 144 through the exit corridor 132 to the discharge loading dock 146. Waste transfer is a two team process with one team remaining in the exit corridor 132 and the second team staying outside the biosecurity area 116 on the discharge loading dock 146. Waste materials may be kept temporarily in waste storage room 148 and dead animals may be studied in necropsy room 150 before being removed from the facility 200.

Waste flow in in the harvesting unit 112 is indicated in FIG. 2A by the arrows extending from transferred from the egg harvesting room 122 to the harvesting unit's loading dock 146.

### Third Exemplary Facility

FIGS. 3A-3B illustrate a similar exemplary protein production facility 300 has been designed to produce up to 1500 liters of egg white per month containing a therapeutic protein or proteins. Protein production facility 300 is substantially similar to protein production facility 200, but the biosecurity area 116 of the protein production facility 300 only has four egg production rooms 114. Material flow through the protein production facility 300 is substantially similar to that described above for the protein production facility 200. Personnel flow through and relative pressurization in the protein production facility 300 are also configured to provide a high degree of biosecurity. This exemplary facility is also designed to provide high efficiency in biopharmaceutical production while also maintaining biosecurity and a GMP compliant environment for egg white harvesting.

Personnel Flow

Personnel do not directly moved between the protein production unit 110 and the harvesting unit 112 of protein production facilities 200, 300. The pass-through 121 is the only direct connection between the protein production unit 110 and the harvesting unit 112. Exemplary personnel flow patterns in protein production facilities are indicated by the arrows on FIG. 3A.

Personnel enter the protein production unit through entry corridor 158. They remove clothing in outer locker rooms 160, bathe in shower rooms 162, and then don internal clothing in inner locker rooms 164 as discussed above. This process is reversed when exiting the protein production facility 300.

Normal two-way traffic is allowed outside the biosecurity area 116 (e.g., to and between egg preparation room 118 egg cold storage room 120, production staging area 152, fog room 154, and storage room 156).

Personnel only enter the biosecurity area 116 through the airlock 126 between the production staging area 152 and the entry corridor 128. In the airlock 126, personnel don a PPE ensemble including, for example, shoe covers, disposable coveralls, mask, hairnets, and gloves on entry. Two-way traffic is permitted along the entry corridor 128 and between the entry corridor 128 and the anterooms 132. Personnel in the biosecurity area 116 do not pass through the airlock 126 between the entry corridor 128 and the corridor leading to the egg preparation room 118 of the production unit 110. Rather, personnel in the biosecurity area 116 place the eggs into of the airlock 126 and personnel in the corridor take the eggs out of the airlock 126. In protein production facility 200, these personnel typically take the eggs directly to pass-through 121 to be transferred into the harvesting unit.

Personnel flow in the remainder of the biosecurity unit is one-way. Once entering the egg production rooms 114, the brooding room 144, or the hatching/breeding rooms 140, 142, personnel proceed through these rooms to the exit corridor 130. Personnel flow in the exit corridor 130 is two-way. Personnel handling waste proceed to the door to loading dock 146 but do not pass-through the door but rather place waste (e.g., biohazard bags, manure) at the boundary of the biosecurity area 116—the door leading to discharge loading dock 146. Waste transfer is a two team process with one team remaining in the exit corridor 132 and the second team staying outside the biosecurity area 116 on the discharge loading dock 146. Personnel in the exit corridor 130 leave the biosecurity area 116 through the airlock 126. Personnel remove their secondary PPE in the airlock 126.

Personnel enter and exit the harvesting unit 112 through administrative spaces that include access to the viewing corridor 170. Personnel must pass-through locker rooms 160 to proceed further into the harvesting unit 112 as the locker rooms provide the only connection between the administrative spaces and the remainder of the harvesting unit 112.

An emergency exit leads from the viewing corridor 170 to the discharge loading dock 146 of the production unit 110. The door of this emergency exit has an alarm to indicate when it has been opened and is monitored by closed circuit camera. The store is only used in emergency situations and personnel exiting the harvesting area through this door pass through the loading dock 146 and exit the building. They do not enter the biosecurity area 116.

Personnel flow through the GMP-compliant egg harvesting room 122 is one-way. Personnel enter the egg harvesting room 122 through the airlock 126 between the egg preparation room 118 and the egg harvesting room 122. Personnel entering the egg white harvesting room 122 don secondary PPE including, for example, shoe covers, disposable coveralls, mask, hairnets, and gloves on entry in the airlock 126. Personnel exit the egg harvesting room 122 through the airlock 126 between the storage room 124 and the egg harvesting room 122 and remove their secondary PPE in the airlock. Personnel flow in the rest of the harvesting unit 112 is two-way.

Relative Pressurization

Relative pressurization of adjacent rooms, particularly in the biosecurity area 116 and egg harvesting room 122, is also managed to control the air flow in the facility 300 when doors are opened.

In the production unit 110, the egg production rooms 114 are maintained at a positive pressure relative to the entry corridor 128 and the exit corridor 130. The anterooms 132 between the entry corridor 128 and the egg production rooms 114 are maintained in a negative pressure relative to the entry corridor 128 and the egg production rooms 114. The airlocks 126 between the production staging room 152 and the entry/exit corridors 128, 130 are maintained at a positive pressure relative to the production staging room 152 and the entry/exit corridors 128, 130. The receiving loading dock 154 and associated storage room 156 are maintained at a negative pressure relative to adjacent portions of the production unit 110. The egg preparation room 118 in the protein production unit 110 is maintained at a negative pressure relative to the adjacent corridors.

In the harvesting unit, the egg white harvesting room 122 is maintained at a positive pressure relative to the airlocks 126 providing access into and out of the egg white harvesting room 122. These airlocks 126 are maintained in a positive pressure relative to the adjacent corridors. The locker rooms 160 are maintained at a negative pressure relative to the connecting rooms.

In conclusion

A number of embodiments have been described. Nevertheless, it will be understood that various modifications may be made without departing from the spirit and scope of the disclosure.

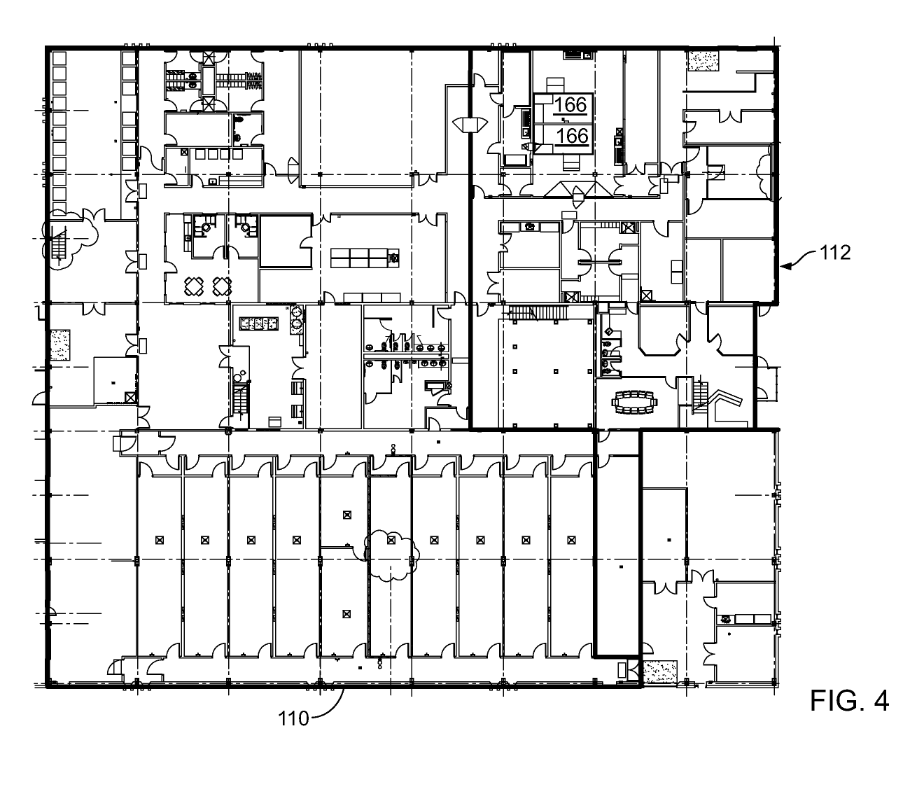

For example, FIG. 4 illustrates an exemplary protein production facility 400 that is substantially similar to the protein production facility 200 except for the configuration of the egg cracking rooms 166. In the protein production facility 400, a soft-walled HEPA filtered room is divided into two egg cracking rooms 166 divided by a central hard Plexiglas wall. Each of the two egg cracking rooms 166 shares a common wall with the egg preparation room 118. Separate pass-throughs extend from the egg preparation room 118 to each of the two egg cracking rooms 166. This exemplary facility also provides high efficiency in biopharmaceutical production while also maintaining biosecurity and a GMP compliant environment for egg white harvesting.

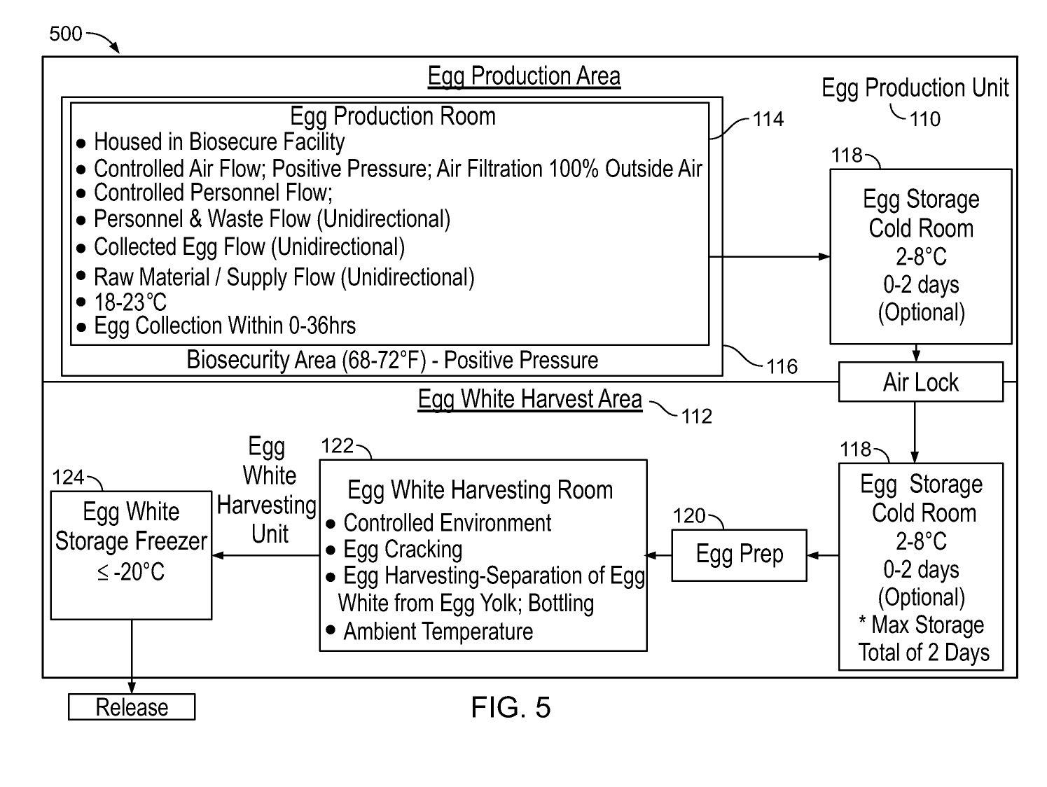

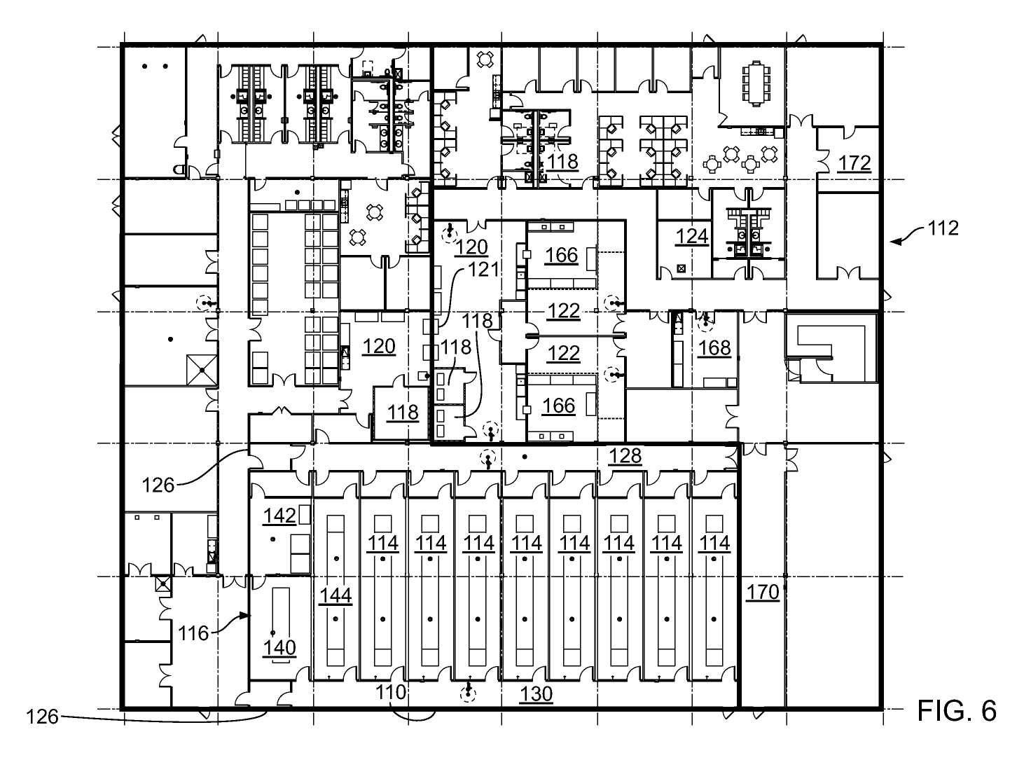

In another example, FIG. 5, shows an exemplary protein production facility 500 that is substantially similar to the protein production facility 100 shown in FIG. 1. FIG. 6 shows a specific exemplary layout for the egg production facility 500. However, in the protein production facility 500, the egg preparation room 120 is in the egg white harvesting unit 112. Both the egg production facility 110 and the white harvesting unit 112 have an egg cold storage room 118. The doors between production room entry corridor 128 and the viewing room 170 are emergency exit doors (strictly used for emergency only).

Accordingly, other embodiments are within the scope of the following claims.

1-39. (canceled)

40. A protein production facility comprising:
an egg production unit in a building, the egg production unit comprising a biosecurity area; and
an egg white harvesting unit in the building, wherein the egg white harvesting unit comprises at least one area that complies with good manufacturing practices.

41. The facility of claim 40, wherein the egg white harvesting unit comprises a harvesting room compliant with good manufacturing practices.

42. The facility of claim 40, comprising between 400 and 20,000 transgenic avian in the biosecurity area.

43. The facility of claim 40, wherein the egg production unit comprises multiple production rooms in the biosecurity area, each production room configured to house between 200 and 1,000 avian.

44. The facility of claim 43, comprising between 400 and 1,000 transgenic avian in each production room.

45. The facility of claim 40, comprising an air handling system for the production rooms that comprises high-efficiency particulate absorption filters.

46. The facility of claim 40, wherein the air handling system is operable to control air flow to the biosecurity area such that air pressure is higher in each of the multiple production rooms than in adjacent rooms accessible from the multiple production rooms.

47. The facility of claim 40, comprising one or more brooding rooms in the biosecurity area.

48. The facility of claim 40, comprising a breeding room housing male avian in the biosecurity area.

49. The facility of claim 40, comprising a hatching room in the biosecurity area.

50. The facility of claim 40, comprising one or more freezers for storing harvested egg white.

51. The facility of claim 40, comprising at least two airlocks disposed for personnel access between the biosecurity area and other portions of the production unit.

52. The facility of claim 40, comprising at least two airlocks disposed for personnel access between the harvesting room and other portions of the egg white harvesting unit.

53. The facility of claim 51, wherein the airlocks are HEPA filtered or are ISO Class 7 compliant.

54. The facility of claim 40, wherein the harvesting room has a low bioburden environment or is ISO Class 7 compliant.

55. The facility of claim 40, wherein the harvesting unit contains at least one HEPA filtered room.

56. The facility of claim 40, wherein the HEPA filtered room is the harvesting room.

57. The facility of claim 54, wherein the HEPA filtered room is ISO Class 8 standards compliant.

58. The facility of claim 54, comprising a pass-through in a common wall between the HEPA filtered room and a portion of the harvesting unit outside harvesting room.

59. The facility of claim 49, wherein the freezer is located in the egg white harvesting unit and maintained at a temperature between −2° and −80° C.

60. The facility of claim 49, wherein the freezer is located in the egg white harvesting unit and maintained at a temperature about −20° C.

61. The facility of claim 49, wherein the freezer is located in the egg white harvesting unit and maintained at a temperature about −80° C.

62. The facility of claim 40, comprising a cold room in biosecurity area for storing eggs.

63. The facility of claim 62, wherein the cold room has an internal temperature set to between 2° C.-10° C.
